(19) United States
(12) Patent Application Publication
(10) Pub. No.: US 2019/0337149 A1
(43) Pub. Date: Nov. 7, 2019

(54) AN ACTUATOR HAVING AT LEAST TWO RODS ARRANGED FOR INDIVIDUALLY MOTION

(71) Applicant: SAAB AB, Linköping (SE)

(72) Inventor: Magnus LANDBERG, Linköping (SE)

(73) Assignee: SAAB AB, Linköping (SE)

(21) Appl. No.: 16/349,872

(22) PCT Filed: Nov. 17, 2016
(86) PCT No.: PCT/SE2016/051136

§ 371 Date: May 14, 2019

(51) Int. Cl. B25J 9/14; B25J 9/10; F15B 11/036; F15B 15/04; F15B 15/14; F15B 15/26; F15B 15/06

(52) U.S. Cl. CPC B25J 9/144; B25J 9/1065; F15B 11/0365; F15B 15/04; F15B 2211/7054; F15B 15/26; F15B 15/1447; F15B 15/061; F15B 2211/7056; F15B 15/1404

(57) ABSTRACT

The present invention regards a fluid actuator arrangement comprising a first cylinder housing comprising a first piston body comprising a first through-bore and a first clamping element provided for releasable clamping onto a first piston rod. The first piston body comprises a second through-bore and a second clamping element provided for releasable clamping onto a second piston rod; a first static holding unit comprising a first clamping unit provided for releasable clamping onto the first piston rod; a second clamping unit provided for releasable clamping onto the second piston rod; a first base member coupled to the first piston rod via a first universal joint for providing a rotational motion of the first base member during longitudinal motion of the first piston rod. The present invention also regards a method for providing a rotational motion of a first base member.

### TECHNICAL FIELD

The present invention relates to a fluid actuator arrangement comprising a first cylinder housing comprising a first piston body comprising a first through-bore and a first clamping element provided for releasable clamping onto a first piston rod, wherein the first piston body comprises a second through-bore and a second clamping element provided for releasable clamping onto a second piston rod; a first static holding unit comprising a first clamping unit provided for releasable clamping onto the first piston rod; a second clamping unit provided for releasable clamping onto the second piston rod; a first base member coupled to the first piston rod via a jointed coupling.

The present invention concerns the industry using hydraulic actuators in compact systems having a fluid actuator that can perform extension and pitch/yaw action. It also concerns the robot industry using such fluid actuator arrangements and components thereof.

### BACKGROUND ART

Current fluid actuator arrangements having a set of servo valves applied to e.g. robots are not cost-effective to produce and operate. The current fluid actuator arrangements are bulky and require additional actuators for controlling the rotational motion (e.g. pitch or yaw of the first base member).

Fluid actuator arrangements are also used for operating different types of robots, e.g. polar coordinate robots or others.

There are several robot manufacturers that may apply different kinds of robot systems for controlling the motion of a robot end effector (e.g. EP2015/063577 to ABB, EP 1 869 282 to Bosch, EP 0 062 070 to Fujitsu Fanuc, JPS6284951 to Fuji Robotics, J P 2001-230193 to Kawasaki Robot, DE 197 48 822 to Kuka AG, JPH 0331058 to Hitachi, EP 1110679A1 to Mitsubishi, J P 2015-071202 to Seiko Epson Corp., JP 2012-210703 to Toshiba Machine, JPH 01193131 to Yamaha etc.).

Furthermore, U.S. Pat. No. 7,108,108 relates to a device for stopping relative movement between a clamp unit and a rod extending through the clamp unit.

U.S. Pat. No. 5,353,687 relates to hydraulic cylinder having three double acting hydraulic cylinders encased in a unitary housing such that the first rod extends from one end of the housing and second and third rods extends from opposite end of the housing.

WO2015195029 discloses an arrangement that can distribute control functionality regarding force and motion rate of a piston rod arrangement developed by SAAB AB. A piston includes a piston rod engagement and disengagement device, which is adapted to engage or disengage the piston to/from the piston rod arrangement.

### SUMMARY OF THE INVENTION

There is an object to provide a compact fluid actuator arrangement of the type defined in the introduction.

There is an object to provide a compact fluid actuator arrangement of the type defined in the introduction that is cost-effective to produce and operate.

A yet further object is to provide a fluid actuator arrangement that can be used for operating e.g. a polar coordinate robot (e.g. spherical robot).

A further object is to provide a fluid actuator arrangement that can be used for operating e.g. a polar coordinate robot (e.g. spherical robot) or other robots.

There is an object to provide incentive for performing an easy and fast trajectory programming of the motion of a robot end effector.

A yet further object is to provide a lightweight fluid actuator arrangement.

One object is to provide a multi-piston rod fluid actuator arrangement designed as single unit.

This or at least one of said objects has been achieved by a fluid actuator arrangement comprising a first cylinder housing comprising a first piston body comprising a first through-bore and a first clamping element provided for releasable clamping onto a first piston rod, wherein the first piston body comprises a second through-bore and a second clamping element provided for releasable clamping onto a second piston rod; a first static holding unit comprising; a first clamping unit provided for releasable clamping onto the first piston rod; a second clamping unit provided for releasable clamping onto the second piston rod; a first base member coupled to the first piston rod via a jointed coupling.

In such way is achieved a compact and cost-effective fluid actuator arrangement.

Preferably, the jointed coupling comprises a first universal joint.

In such way is achieved that pitch and yaw motions (separately or in combination) of the first base member can be provided relative the first and second piston rods and/or pitch and yaw motions (separately or in combination) of the first and second piston rods relative a fundament.

Suitably, a first universal joint is arranged to provide self-adjusting motion of a first outermost end of the first piston rod relative the first base member by a sliding action of the first outermost end essentially transverse the axial direction relative the first base member.

Preferably, a second universal joint is arranged to provide self-adjusting motion of a second outermost end of the second piston rod relative the first base member by a sliding action of the second outermost end essentially transverse the axial direction relative the second base member.

Suitably, a third universal joint is arranged to provide self-adjusting motion of a third outermost end of a third piston rod relative the fundament by a sliding action of the third outermost end essentially transverse the axial direction relative the fundament.

Preferably, a fourth universal joint is arranged to provide self-adjusting motion of a fourth outermost end of a fourth piston rod relative the fundament by a sliding action of the fourth outermost end essentially transverse the axial direction relative the fundament.

Suitably, the first base member being coupled to the first piston rod via the jointed coupling for providing a rotational motion of the first base member during longitudinal motion of the first piston rod and and/or second piston rod coupled to the fundament.

Thereby is achieved that a rotational motion of the first base member and/or the fundament is achieved by moving the respective piston rod (or at least one of the piston rods) in a longitudinal motion.

Preferably, the fluid actuator arrangement comprises a second static holding unit provided for releasable clamping onto the second piston rod.

Suitably, the first base member is coupled to the first piston rod for providing longitudinal motion of the first base member in an axial direction, wherein the second piston rod is coupled to the first base member or coupled to a second base member of the fluid actuator arrangement for providing a rotational motion of the first base member.

Thereby is achieved a solution in which multiple piston rods may use a common piston body, which transfer simultaneous movement to a number of piston rods and by which solution each piston rod is connected individually to one or more piston bodies, each comprising individual clamping elements (and/or clamping members).

In such way is achieved a fluid actuator arrangement that is compact and cost-effective to produce and operate and which can move a first base member forward and backward and pitch and yaw by means of a plurality of piston rods arranged in at least a first piston body.

Thereby is provided a fluid actuator arrangement that can be used for operating e.g. a polar coordinate robot (e.g. spherical robot) comprising a fundament, about which the fluid actuator arrangement can be pivoted (e.g. yaw and pitch motion), wherein the fluid actuator arrangement also can perform telescoping (longitudinal) and rotational motion of the first base member (e.g. a robot end effector). Such robot comprises one linear axis and two rotary axes and can be used in a variety of industrial tasks such as welding and material handling. Thereby is achieved that the capital expenditure can be lowered in view of current robot designs. In such way is achieved that small and medium-sized enterprises (SMEs) may be able to afford such kind of robots. SMEs often need to alter between different products and produce in small batches. By means of low capital expenditure cost there is achieved that a user also can use such a robot for minor serial production.

By means of the first static holding unit there is achieved high rigidity and precision of the fluid actuator arrangement.

Suitably, the second base member constitutes a fundament.

Preferably, the rotational motion is defined as a yaw motion, which provides a yaw motion of the fluid actuator arrangement about a fundament and/or provides a yaw motion of the first base member about a universal joint of the first and/or second and/or third piston rod.

Suitably, the rotational motion is defined as pitch and/or yaw motion, which provides a rotational motion of the first base member about a universal joint of an optional piston rod.

Preferably, the first piston body divides the first cylinder housing in a first and second cylinder chamber, each first and second cylinder chamber is coupled to a fluid supply via a valve arrangement for controlling the pressurization of the respective first and second cylinder chamber.

Suitably, the fluid actuator arrangement comprises a control unit coupled to the valve arrangement for controlling the motion of the first piston body (and optionally of a second piston body) by the pressurization of the respective first and second cylinder chamber.

Preferably, the valve arrangement comprises a logic valve member, e.g. a micro-valve or others.

Suitably, the valve arrangement controls the pressurization of the respective clamping element and/or clamping member.

In such way is achieved a switching time of a few milliseconds. The use of logic valve members implies that small valves can be used having low power consumption because of the low flow operation and small volume changes in the respective space of each clamping element and/or clamping member during pressurization.

With a small electric control current in the logic valve member, a large axial force in the piston can be controlled in a simple way. A large mechanical force in the piston rod can be controlled in a manner similar to how a small gate current in a transistor can control a much larger current. Micro-valves may be placed as an extension of the part of the protruding piston, outside the cylinder. The supply of hydraulic power to the valves is done via a common thin hose and a thin electric multi cable. In order to decrease the clamping element area a higher control pressure may be used. The used clamping technology allows clamping pressures up to 45 MPa.

Preferably, a sensor arrangement is provided to the fluid actuator arrangement for sensing the actual position (e.g. angular and/or linear position) of the respective first and second (and optionally of a third, fourth and fifth) piston rod.

Suitably, the first clamping element comprises a flexible membrane formed by an inner wall forming a space of the first piston body coupled for fluid communication with a fluid supply via a fluid port positioned outside the first cylinder housing.

Preferably, the second clamping element comprises a flexible membrane of a space of the first piston body coupled for fluid communication with a fluid supply via a fluid port positioned outside the first cylinder housing.

Suitably, the clamping (engaging) and/or releasing (disengaging) is achieved by pressurizing a flexible membrane of the respective first and second (optionally a third, fourth, fifth) clamping element of the first piston body.

Preferably, the fluid actuator arrangement further comprising a third piston rod arranged through; a third through-bore of the first piston body and a third clamping element provided for releasable clamping onto the third piston rod; the first static holding unit comprising a third clamping unit provided for releasable clamping onto the third piston rod.

Suitably, the fluid actuator arrangement further comprising at least four piston rods, each of which is arranged through an individual through-bore of the first piston body and an individual clamping element provided for releasable clamping onto the respective piston rod, wherein each of which is arranged through an individual clamping unit of the a first static holding unit provided for releasable clamping onto the respective piston rod.

Preferably, the actuator arrangement further comprises a second cylinder housing comprising a second piston body comprising a first through-hole and a first clamping member provided for releasable clamping onto the first piston rod, wherein the second piston body comprises a second through-hole and a second clamping member provided for releasable clamping onto the second piston rod.

Preferably, the second piston body divides the second cylinder housing in a first and second cylinder chamber, each first and second cylinder chamber is coupled to a fluid supply via a valve arrangement for controlling the pressurization of the respective first and second cylinder chamber. Suitably, the first clamping member comprises a flexible membrane) formed by an inner wall forming a space of the second piston body coupled for fluid communication with a fluid supply via a fluid port positioned outside the second cylinder housing.

Preferably, the second clamping member comprises a flexible membrane of a) formed by an inner wall forming a space of the second piston body coupled for fluid communication with a fluid supply via a fluid port positioned outside the second cylinder housing.

Suitably, each third, fourth, fifth clamping member comprises a respective flexible membrane of a an inner wall forming a space of the second piston body coupled for fluid communication with a fluid supply via a fluid port positioned outside the second cylinder housing.

In such way there is provided a smooth motion of the first base member.

Preferably, the first piston body comprises a first through-bore and a first clamping element provided for releasable clamping onto a first piston rod; a second through-bore and a second clamping element provided for releasable clamping onto a second piston rod; a third through-bore and a third clamping element provided for releasable clamping onto a third piston rod; a fourth through-bore and a fourth clamping element provided for releasable clamping onto a fourth piston rod; a fifth through-bore and a fifth clamping element provided for releasable clamping onto a fifth piston rod, wherein the first piston rod is coupled to the first base member for providing a linear motion of the first base member, the respective second and third piston rod is coupled to the first base member for providing a rotational motion of the first base member relative the first piston body; the respective fourth and fifth piston rod is coupled to the second base member for providing a rotational motion of the first piston body.

Suitably, the second piston body comprises a first through-hole and a first clamping member provided for releasable clamping onto the first piston rod; a second through-hole and a second clamping member provided for releasable clamping onto the second piston rod; a third through-hole and a third clamping member provided for releasable clamping onto the third piston rod; a fourth through-hole and a fourth clamping member provided for releasable clamping onto the fourth piston rod; a fifth through-hole and a fifth clamping member provided for releasable clamping onto the fifth piston rod.

Preferably, the first base member is coupled to a first end of the first piston rod and/or to a first end of the second piston rod and/or to a first end of the third piston rod.

Suitably, the second base member is coupled to the first cylinder housing and/or the first static holding unit and/or the second cylinder housing and is coupled to a first end of the fourth piston rod and/or to a first end of the fifth piston rod.

Preferably, each third, fourth, fifth clamping element comprises a respective flexible membrane formed by an inner wall forming a space of the first piston body coupled for fluid communication with a fluid supply via a fluid port positioned outside the first cylinder housing.

Suitably, the first base member is coupled to the first piston rod via a first universal joint and is coupled to the second piston rod via a second universal joint or the first base member is coupled to the first piston rod via the first universal joint and the second base member is coupled to the second piston rod via a third universal joint.

Preferably, the first piston rod is coupled to the first base member via a first universal joint, the second piston rod is coupled to the first base member via a second universal joint, the third piston rod is coupled to the first base member via a third universal joint, the fourth piston rod is coupled to the second base member via a fourth universal joint, the fifth piston rod is coupled to the second base member via a fifth universal joint.

Suitably, the second universal joint and the third universal joint are arranged in elongated guide members that are oriented perpendicular to each other in a plane substantially extending transverse the axial direction; the fourth universal joint and the fifth universal joint are arranged in elongated guide members oriented perpendicular to each other, the respective elongated guide member is provided for guidance of the respective universal joint along the respective elongated guide member.

Preferably, one or at least two universal joint may be rigidly coupled to the base plate and only a single universal joint may be slidingly arranged in said elongated guide member.

Preferably, the second base member is coupled to the first cylinder housing and/or the first static holding unit and/or a second cylinder housing via a sixth universal joint.

Suitably, the first base member comprises a robot end effector.

Suitably, the first base member comprises a reconfigurable fixture unit provided for holding articles during assembly.

This is also solved by a method for providing a rotational motion of a first base member of a fluid actuator arrangement comprising a first cylinder housing comprising; a first piston body comprising a first through-bore and a first clamping element provided for releasable clamping onto a first piston rod, wherein the first piston body comprises a second through-bore and a second clamping element provided for releasable clamping onto a second piston rod; a first static holding unit comprising; a first clamping unit provided for releasable clamping onto the first piston rod; a second clamping unit provided for releasable clamping onto second piston rod; a first base member coupled to the first piston rod via a jointed coupling for providing a rotational motion of the first base member during longitudinal motion of the first piston rod when clamped on the first piston rod, wherein the method comprises the steps of: clamping the first piston rod by means of the first clamping element; clamping the second clamping unit for holding the second piston rod; and moving the first piston body.

This is also solved by a method for providing a linear and rotational motion of a first base member of a fluid actuator arrangement comprising a first cylinder housing comprising; a first piston body comprising a first through-bore and a first clamping element provided for releasable clamping onto a first piston rod, wherein the first piston body comprises a second through-bore and a second clamping element provided for releasable clamping onto a second piston rod; a first static holding unit comprising; a first clamping unit provided for releasable clamping onto the first piston rod; a second clamping unit provided for releasable clamping onto second piston rod; a first base member coupled to the first piston rod for providing longitudinal motion in an axial direction, wherein the second piston rod is coupled to the first base member or coupled to a second base member of the fluid actuator arrangement for providing a rotational motion of the first base member, the method comprises the steps of: clamping the first piston rod by means of the first clamping element; moving the first piston body to a first position; clamping the first clamping unit for holding the first piston rod; clamping the second piston rod by means of the second clamping element; releasing the first clamping element from the first piston rod; and moving the first piston body to a second position.

Preferably, the engaging (clamping) is achieved by a first pressure.

Suitably, disengaging (releasing) is achieved by a second pressure being lower than the first pressure.

Preferably, the engaging and/or disengaging can be achieved by pressurizing a flexible membrane of the respective first and second (optionally a third, fourth, fifth) clamping element of the first piston body.

Suitably, the engaging and/or disengaging can be achieved by pressurizing a flexible membrane of the respective first and second (optionally a third, fourth, fifth) clamping member of a second piston body.

Preferably, the engaging and/or disengaging can be achieved by pressurizing a flexible membrane of the respective first and second (optionally a third, fourth, fifth) clamping unit of the first static holding unit.

Suitably, the method comprises step of disengaging the first and second (and optionally a third, fourth and fifth) clamping unit and disengaging the first piston body (and optionally a second piston body) from the respective first and second (and optionally a third, fourth and fifth) piston rod. Preferably, the sensor arrangement is adapted to sense the actual position of the respective first and second (and optionally of a third, fourth and fifth) piston rod.

In such way is achieved that a user/operator can perform an easy and fast trajectory programming of the motion of the first base member by manually moving the first base member between desired operation positions.

Thereby is achieved any need of special data programmer is eliminated, which in turn is cost-effective.

In such way is provided a simplified interface man-machine communication (data).

Preferably, the first piston body further comprising: a third through-bore and a third clamping element provided for releasable clamping onto a third piston rod; a fourth through-bore and a fourth clamping element provided for releasable clamping onto a fourth piston rod; a fifth through-bore and a fifth clamping element provided for releasable clamping onto a fifth piston rod, the first static holding unit further comprising; a third clamping unit provided for releasable clamping onto the third piston rod; a fourth clamping unit provided for releasable clamping onto the fourth piston rod; a fifth clamping unit provided for releasable clamping onto the fifth piston rod; the first piston rod is coupled to the first base member for providing a linear motion of the first base member, the respective second and third piston rod is coupled to the first base member for providing a rotational motion of the first base member relative the first piston body; the respective fourth and fifth piston rod is coupled to the second base member for providing a rotational motion of the first piston body, the method comprises in optional order the steps of: clamping the first piston rod by means of the first clamping element; moving the first piston body to a first position; clamping the first clamping unit for holding the first piston rod and/or clamping the second clamping unit for holding the second piston rod; clamping the second a piston rod by means of the second clamping element and/or the third piston rod by means of the third clamping element; releasing the first clamping element; and moving the first piston body to a second position.

Suitably, the method comprises in optional order or at the same time the further step of: clamping the first clamping unit for holding the first piston rod; clamping the second clamping unit for holding the second piston rod; clamping the third clamping unit for holding the third piston rod;

releasing the first clamping element from the first piston rod; releasing the second clamping element from the second piston rod; releasing the third clamping element from the third piston rod; clamping the fourth piston rod by means of the fourth clamping element and/or clamping the fifth piston rod by means of the fifth clamping element; and moving the first piston body to a third position.

Preferably, the step of moving the first piston body to the first and/or second position comprises the step of moving the first piston body a first full length stroke.

Suitably, the fluid actuator arrangement further comprising a second cylinder housing comprising a second piston body comprising: a first through-hole and a first clamping member provided for releasable clamping onto the first piston rod; a second through-hole and a second clamping member provided for releasable clamping onto the second piston rod; a third through-hole and a third clamping member provided for releasable clamping onto a third piston rod; a fourth through-hole and a fourth clamping member provided for releasable clamping onto a fourth piston rod; a fifth through-hole and a fifth clamping member provided for releasable clamping onto a fifth piston rod, the method comprises in optional order the steps of: clamping the first piston rod by means of the first clamping member; moving the second piston body to a first point; clamping the first clamping unit for holding the first piston rod and/or clamping the second clamping unit for holding the second piston rod; clamping the second a piston rod by means of the second clamping member and/or the third piston rod by means of the third clamping member; releasing the first clamping member; and moving the second piston body to a second point.

Preferably, the first piston rod and/or second piston rod are made hollow for saving weight.

Suitably, each third, fourth, fifth clamping member comprises a respective flexible membrane formed by an inner wall forming a space of the second piston body coupled for fluid communication with a fluid supply via a fluid port positioned outside the second cylinder housing.

This is also solved by a robot apparatus comprising a control unit configured to control the motion of a first base member, wherein the control unit is coupled to a fluid actuator arrangement according to claim 1-13 and is configured to operate the motion of the first base member according to any of method claims 14 to 19.

This is also solved by a reconfigurable fixture unit provided for holding articles during assembly, which reconfigurable fixture unit comprises a control unit configured to control the motion of a first base member, the control unit is coupled to a fluid actuator arrangement according to claim 1-13 and is configured to operate the motion of the first base member according to any of method claims 14 to 19.

This is also solved by a data medium storing program adapted for providing a motion of a first base member of a robot apparatus according to claim 20 or of a reconfigurable fixture unit according to claim 21, wherein said data medium storing program comprises a program code stored on a medium, which is readable on a computer, for causing the control unit to perform the method steps of: clamping the first piston rod by means of the first clamping element; clamping the second clamping unit for holding the second piston rod; and moving the first piston body.

This is also solved by a data medium storing program product comprising a program code stored on a medium, which is readable on a computer, for performing the method steps according to method claims 14 to 19, when a data medium storing program according to claim 22 is run on the control unit.

Preferably, the method comprises the step of providing a trajectory programming the motion of the first base member by moving the first base member between desired operation positions.

Suitably, the fluid actuator arrangement comprises a sensor arrangement coupled to a control unit adapted to control the motion of the first piston rod according to a feedback loop and adapted to compare a desired position value with an actual position value of the position of the first piston rod relative the first cylinder housing.

Preferably, the fluid actuator arrangement is adapted for a closed loop using a position sensor and/or an angular sensor coupled to the control unit

Suitably, the control unit is adapted to be fed with an input signal and is adapted to command the valve arrangement to pressurize the suitable cylinder chambers

Preferably, the piston body is engaged with suitable piston rod and moves the piston rod to a position defined by a desired position value.

Suitably, the actual position value of the piston rod is measured by means of the position sensor and/or the actual position value of first base member is measured by means of the angular sensor.

Preferably, the actual position value is compared with the desired position value by means of the control unit.

The definition of yaw and

### BRIEF DESCRIPTION OF THE DRAWINGS

The present invention will now be described by way of examples with references to the accompanying schematic drawings, of which:

FIG. 1a illustrates a fluid actuator arrangement according to a first example of the invention;

FIGS. 1b to 1c illustrate a fluid actuator arrangement according to a second example of the invention;

FIGS. 2a to 2e illustrate a fluid actuator arrangement according to a third example of the invention;

FIG. 3 illustrates a fluid actuator arrangement according to a fourth example of the invention;

FIGS. 4a to 4d illustrate a fluid actuator arrangement according to a fifth example of the invention;

FIG. 5 illustrates a robot according to one aspect of the invention;

FIGS. 6a to 6b illustrate a fluid actuator arrangement according to a sixth example of the invention;

FIG. 7 illustrates a reconfigurable fixture unit comprising fluid actuator arrangement according to one aspect of the invention;

FIGS. 8 to 9 schematically illustrate exemplary flow charts of methods for providing a linear and rotational motion of a first base member of a fluid actuator arrangement according to further aspects of the invention;

FIG. 10 illustrates a CPU device according to an example of the invention;

FIGS. 11a to 11b illustrate a fluid actuator arrangement according to one embodiment; and

FIG. 12 illustrates a fluid actuator arrangement adapted for a feedback loop using a sensor arrangement coupled to the control unit

### DETAILED DESCRIPTION

Hereinafter, embodiments of the present invention will be described with reference to the accompanying drawings, wherein for the sake of clarity and understanding of the invention some details of no importance may be deleted from the drawings. Same reference may indicate similar detail, even though it refers to another embodiment.

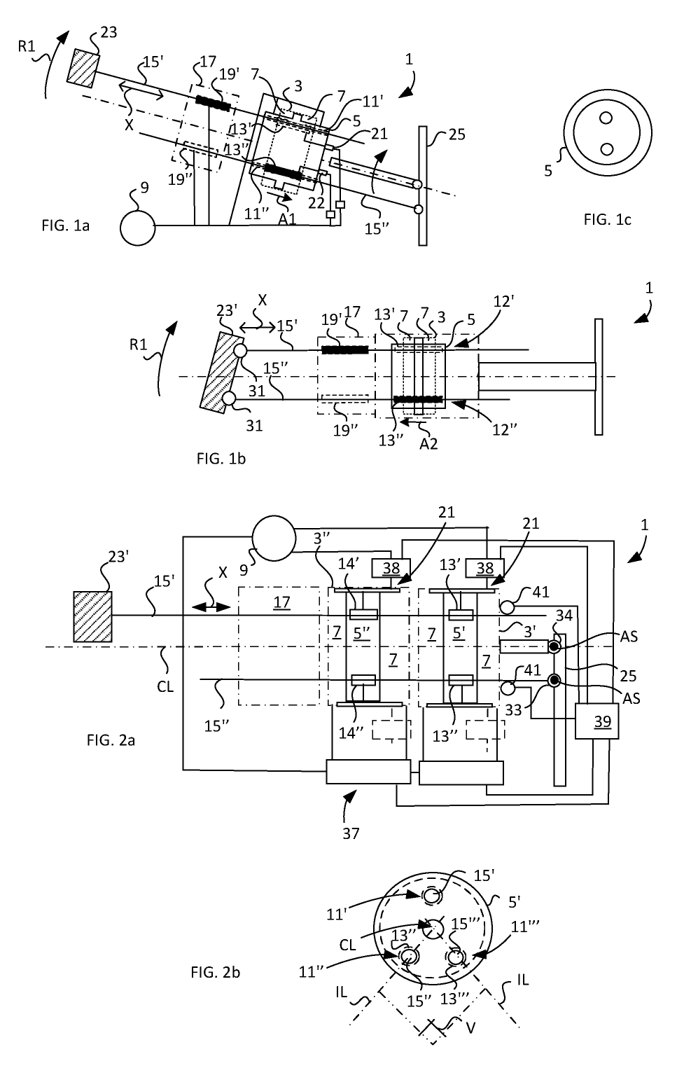

FIG. 1a schematically illustrates a fluid actuator arrangement 1 according to a first example of the invention. The fluid actuator arrangement 1 comprises a cylinder housing 3. The cylinder housing 3 comprises a piston body 5, slidingly arranged in the cylinder housing 3 and can be moved upon pressurizing of a respective cylinder chamber 7 by mean of a fluid supply 9. The piston body 5 comprises a first through-bore 11′ and a first clamping element 13′. The first clamping element 13′ is provided for releasable clamping onto a first piston rod 15′. The piston body 5 further comprises a second through-bore 11″ and a second clamping element 13″. The second clamping element 13″ is provided for releasable clamping onto a second piston rod 15″.

The fluid actuator arrangement 1 further comprises a static holding unit 17. The static holding unit 17 comprises a first clamping unit 19′ (e.g. configured as a sleeve unit) provided for releasable clamping onto the first piston rod 15′. The static holding unit 17 further comprises a second clamping unit 19″ provided for releasable clamping onto the second piston rod 15″. The first clamping element 13′ comprises a flexible membrane (not shown) serving as a flexible wall of a space formed within the piston body 5 and co-axial with the first piston rod 15′. The space is coupled to the fluid supply 9 for fluid communication via a first fluid port 21 positioned exterior the cylinder housing 3.

The second clamping element 13″ comprises a flexible membrane (not shown) serving as a flexible wall of a space formed within the piston body 5 and co-axial with the second piston rod 15″. The space is coupled to the fluid supply 9 for fluid communication via a second fluid port 22 positioned exterior the cylinder housing 3. The first clamping unit 19′ comprises a flexible membrane (not shown) serving as a flexible wall of a space formed within the static holding unit 17 and co-axial with the first piston rod 15′. The space is coupled to the fluid supply 9. The second clamping unit 19″ comprises a flexible membrane (not shown) serving as a flexible wall of a space formed within the static holding unit 17 and co-axial with the second piston rod 15″. The space is coupled to the fluid supply 9.

The fluid actuator arrangement 1 further comprises a tool 23 coupled to the first piston rod 15′ for providing longitudinal motion of the tool 23 in an axial direction X. The second piston rod 15″ is in turn coupled to a fundament 25 around which the cylinder housing 3 and the first and second piston rods 15′, 15″ can rotate. By clamping the second piston rod 15″ by means of the second clamping element 13″ and releasing the first clamping element 13′ from the first piston rod 15′ and by moving the piston body 5 according to the arrow A1, there will be provided a rotational motion of the tool 23 according to arrow R1.

Each space is coupled to the fluid supply 9 via a respective valve member, each of which is controlled by a control unit (not shown).

FIG. 1b schematically illustrates a fluid actuator arrangement 1 according to a second example of the invention. The fluid actuator arrangement 1 comprises a cylinder housing 3. The cylinder housing 3 comprises a piston body 5, slidingly arranged in the cylinder housing 3 and can be moved upon pressurizing of a respective cylinder chamber 7 by mean of a fluid supply (not shown). The piston body 5 comprises a first through-bore 12′ and a first clamping element 13′. The first clamping element 13′ is provided for releasable clamping onto a first piston rod 15′. The piston body 5 further comprises a second through-bore 12″ and a second clamping element 13″. The second clamping element 13″ is provided for releasable clamping onto a second piston rod 15″.

The fluid actuator arrangement 1 further comprises a static holding unit 17. The static holding unit 17 comprises a first clamping unit 19′ (e.g. configured as a sleeve unit) provided for releasable clamping onto the first piston rod 15′. The static holding unit 17 further comprises a second clamping unit 19″ provided for releasable clamping onto the second piston rod 15″. The first clamping element 13′ comprises a flexible membrane (not shown) serving as a flexible wall of a space formed within the piston body 5 and co-axial with the first piston rod 15′. The space is coupled to the fluid supply for fluid communication via a first fluid port (not shown) positioned exterior the cylinder housing 3. The second clamping element 13″ comprises a flexible membrane (not shown) serving as a flexible wall of a space formed within the piston body 5 and co-axial with the second piston rod 15″. The space is coupled to the fluid supply for fluid communication via a second fluid port (not shown) positioned exterior the cylinder housing 3.

The first clamping unit 19′ comprises a flexible membrane (not shown) serving as a flexible wall of a space formed within the static holding unit 17 and co-axial with the first piston rod 15′. The space is coupled to the fluid supply. The second clamping unit 19″ comprises a flexible membrane (not shown) serving as a flexible wall of a space formed within the static holding unit 17 and co-axial with the second piston rod 15″. The space is coupled to the fluid supply.

Each space is coupled to the fluid supply via a respective valve member (not shown), each valve member being controlled by a control unit (not shown).

The fluid actuator arrangement 1 further comprises a holding plate 23′ coupled to the first piston rod 15′ for providing longitudinal motion of the holding plate 23′ in an axial direction X. The second piston rod 15″ is in turn also coupled to the holding plate 23′. The holding plate 23′ is configured to be able to rotate around a universal joint 31 arranged between an end of the first piston rod 15′ and the holding plate 23′. By clamping the second piston rod 15″ by means of the second clamping element 13″ and releasing the first clamping element 13′ from the first piston rod 15′ and clamping the first clamping unit 19′ around the first piston rod 15′ and by moving the piston body 5 according to the arrow A2, there will be provided a rotational motion of the holding plate 23′ according to arrow R2.

FIG. 1c schematically illustrates a cross-section of the piston body 5 in FIG. 1b.

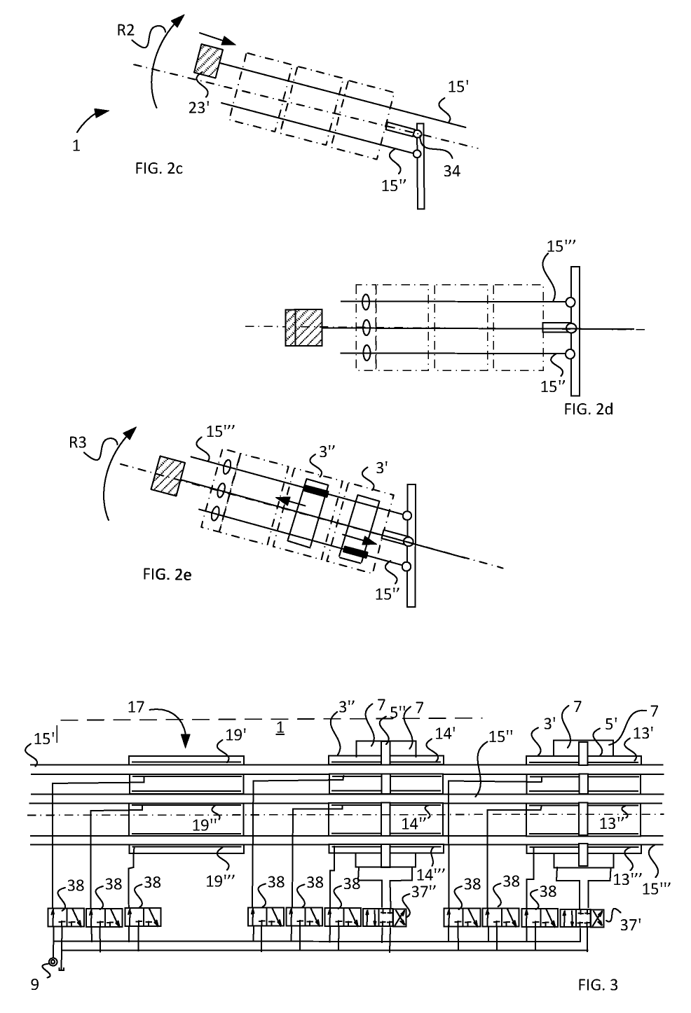

FIGS. 2a to 2e schematically illustrate a fluid actuator arrangement 1 according to a second example of the invention. FIG. 2a illustrates the fluid actuator arrangement 1 comprising a first cylinder housing 3′ including a first piston body 5, which in turn comprises a first through-bore 11′ (see FIG. 2b) and a first clamping element 13′ provided for releasable clamping onto a first piston rod 15′ for linear motion of a first base member 23′, wherein the first piston body 5′ comprises a second through-bore 11″ (see FIG. 2b) and a second clamping element 13″ provided for releasable clamping onto a second piston rod 15″ coupled to a universal joint 33 of a fundament 25. The fluid actuator arrangement 1 further comprises a third piston rod 15′″ (see FIG. 2b) arranged through a third through-bore 11′″ of the first piston body 5′ and a third clamping element 13′″ provided for releasable clamping onto the third piston rod 15′″ also coupled to a universal joint of the fundament 25.

The fluid actuator arrangement 1 further comprises a second cylinder housing 3″, which comprises a second piston body 5″ comprising a first through-hole and a first clamping member 14′ provided for releasable clamping onto the first piston rod 15′. The second piston body 5″ comprises a second through-hole and a second clamping member 14″ provided for releasable clamping onto the second piston rod 15″. The a fluid actuator arrangement 1 further comprises a first static holding unit 17 comprising a first clamping unit (not shown) provided for releasable clamping onto the first piston rod 15′ and comprises a second clamping unit (not shown) provided for releasable clamping onto the second piston rod 15″. The first static holding unit 17 further comprises a third clamping unit (not shown) provided for releasable clamping onto the third piston rod 15′″ (see FIG. 2b). The first base member 23′ is thus coupled to the first piston rod 15′ for providing longitudinal motion of the first base member 23′ in an axial direction X (the second and third clamping element 13″, 13′″ and the second and third clamping member 14″, 14″ being released), wherein the second 15″ and third 15″ piston rods are coupled to the fundament 25 of the fluid actuator arrangement 1 for providing a rotational motion of the first base member 23′ (i.e. yaw and elevating motion of the fluid actuator arrangement 1).

The first piston body 5′ divides the first cylinder housing 3′ in a first and second cylinder chamber 7, each first and second cylinder chamber 7 is coupled to a fluid supply 9 via a valve arrangement 37 for controlling the pressurization of the respective first and second cylinder chamber 7. The second piston body 5″ divides the second cylinder housing 3″ in a first and second cylinder chamber 7, each first and second cylinder chamber 7 of the second cylinder housing 3″ is coupled to the fluid supply 9 via the valve arrangement 37 for controlling the pressurization of the respective first and second cylinder chamber 7 of the second cylinder housing 3″. A control unit 39 is coupled to the valve arrangement 37 for controlling the motion of the first and second piston body 5′, 5″ by the pressurization of the respective first and second cylinder chamber 7 in an alternating manner.

A sensor arrangement 41 (e.g. a linear sensor device) is coupled to the control unit 39 for detecting the actual position of the respective first, second, third piston rod 15′, 15″, 15″. Each clamping element 13′, 13″, 13′″/clamping member 14′, 14″, 14″ comprises a respective flexible membrane (not shown) formed by an inner wall forming a respective space of the first/second piston body 5′, 5″. Each space is coupled for fluid communication with the fluid supply 9 via a respective fluid port 21 positioned outside the first/second cylinder housing 3′, 3″ and via a respective logic valve 38. Each clamping unit comprises a respective flexible membrane (not shown) formed by an inner wall forming a respective space of the first static holding unit 17. Each space is coupled for fluid communication with the fluid supply 9 via a respective logic valve. The clamping (engaging) and/or releasing (disengaging) is achieved by pressurizing the respective flexible membrane of the respective first, second, third clamping element/member and the respective clamping unit by a first pressure and/or a second pressure. The first pressure for clamping is higher than the second pressure for releasing.

The first and second cylinder housings 3′, 3″ and the static holding unit 17 are rigidly coupled to each other making one single unit and being coupled to the fundament 25 via a main universal joint 34.

The fluid actuator arrangement 1 is preferably adapted for a feedback loop or closed loop using the sensor arrangement (e.g. position sensor 41 and/or angular sensor AS) being coupled to the control unit 39. As being schematically shown in FIG. 12 the control unit is fed with an input signal (INPUT) (command). The control unit 39 (CONTROL UNIT) commands the valve arrangement 37 to pressurize the suitable cylinder chamber 7 for moving the piston body 5′, 5″ (PISTON). The piston body is engaged with suitable piston rod (ROD) and moves the piston rod to a position defined by a desired position value. The actual position value of the piston rod is measured by means of the position sensor 41 (SENSOR) and/or the actual (rotated) position value of first base member 23′ is measured by means of the angular sensor AS (SENSOR). The actual position value is compared with the desired position value by means of the control unit 39.

FIG. 2b schematically shows a cross-sectional view of the first piston body 5′. It shall be noted that the second 15″ and third 15′″ piston rods are positioned (seen in a plane transversal to the axial direction X) relative each other so that a respective intersecting line IL of each rod intersects a centre line CL (being parallel with the axial direction X) of the universal joint 34 and the centre line of the respective second and third piston rod 15″, 15′″ with an angle V of 90 degrees. FIG. 2c schematically shows, in a view from the side, the fluid actuator arrangement 1 in a position wherein the second and third piston rods 15″, 15′″ are pushed thus pivoting the fluid actuator arrangement 1 around the main universal joint 34 in the rotational direction R2.

The first base member 23′ is retracted by clamping the first piston rod 15′ by means of the first 5′ and second 5″ piston bodies, which also at the same time provide said pushing of the second 15″ and third 15′″ piston rods. FIGS. 2d and 2e schematically show the fluid actuator arrangement 1 in a view from above. In FIG. 2e is shown that the second piston rod 15″ is pushed from the first and second cylinder housings 3′, 3″ and the third piston rod 15′″ is pulled towards the first and second cylinder housings 3′, 3″, wherein the fluid actuator arrangement 1 is pivoted in a rotational direction R3.

FIG. 3 illustrates a fluid actuator arrangement 1 according to a fourth example of the invention more in detail regarding the clamping features and valve arrangement. A first piston body 5′ divides a first cylinder housing 3′ in a first and second cylinder chamber 7, each first and second cylinder chamber 7 is coupled to a fluid supply 9 via a first direction valve 37′ for controlling the pressurization of the respective first and second cylinder chamber 7 of the first cylinder housing 3′. A second piston body 5″ divides a second cylinder housing 3″ in a first and second cylinder chamber 7; each first and second cylinder chamber 7 is coupled to the fluid supply 9 via a second direction valve 37″ for controlling the pressurization of the respective first and second cylinder chamber 7 of the second cylinder housing 3″.

A respective first, second, third clamping element 13′, 13″, 13′″ of the first piston body 5′ is coupled to the fluid supply 9 via a respective first, second, third logic valve 38, e.g. a micro-valve. A respective first, second, third clamping member 14′, 14″, 14′″ of the second piston body 5″ is coupled to the fluid supply 9 via a respective fourth, fifth, sixth logic valve 38, e.g. a micro-valve. A respective first, second, third clamping unit 19′, 19″, 19′″ of the static holding unit 17 each being coupled to the fluid supply 9 via a respective seventh, eighth, ninth logic valve 38. The first/second/third clamping element 13′, 13″, 13′″ each comprises a flexible membrane formed by an inner wall forming a space of the first piston body 5′ and is coupled for fluid communication with the fluid supply 9 via a fluid port positioned outside the first cylinder housing 3′. The first/second/third clamping member 14′, 14″, 14′″ each comprises a flexible membrane formed by an inner wall forming a space of the second piston body 5″ and is coupled for fluid communication with the fluid supply 9 via a fluid port positioned outside the second cylinder housing 3″.

The first/second/third 19′, 19″, 19′″ clamping unit each comprises a flexible membrane formed by an inner wall forming a space of the static holding unit 17 body and is coupled for fluid communication with the fluid supply 9 via a fluid port positioned outside the static holding unit. In such way is achieved a switching time of a few milliseconds for pressurization of the respective space and clamping action. The use of logic valve 38 members implies that small valves can be used having low power consumption because of the low flow operation and small volume changes in the respective space of each clamping element and/or clamping member and/or clamping unit during pressurization.

Suitable valves, such as micro-valves, cartridge valves and others, may also be placed as an extension of the part of the protruding portion (protruding in the axial direction from the cylinder housing) of the piston body.

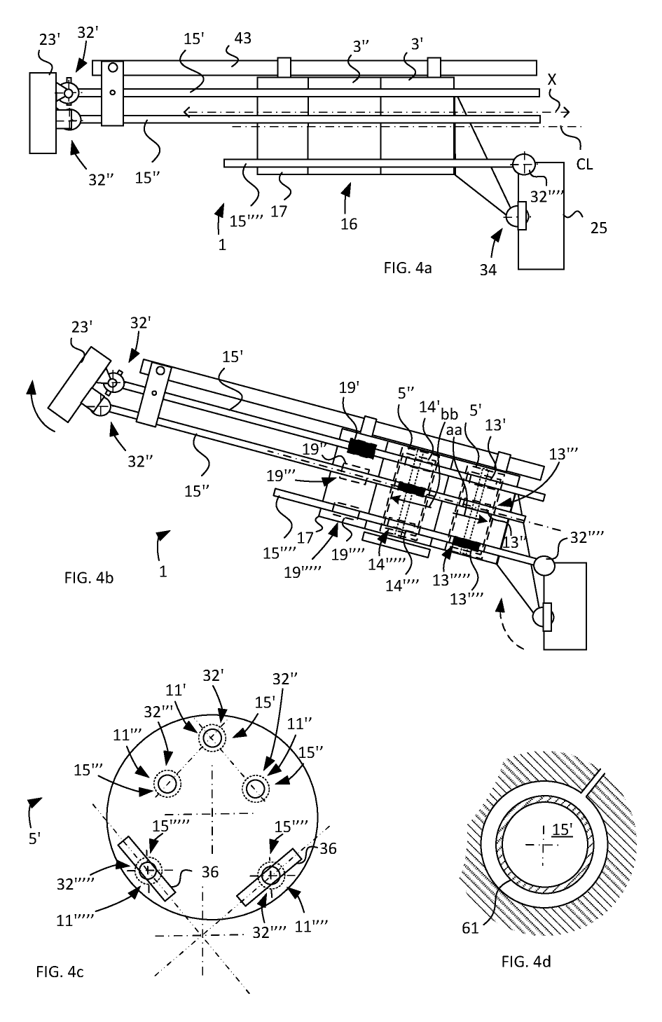

FIGS. 4a to 4c schematically illustrate a fluid actuator arrangement 1 according to a fifth example of the invention. FIG. 4a illustrates the fluid actuator arrangement 1 in a view from the side. A respective first and second cylinder housing 3′, 3″ is rigidly coupled to a static holding unit 17 forming an actuator block 16 extending along an axial direction X defining a centre line CL. The actuator block 16 is pivotally hinged to a fundament 25 via a universal pivot joint 34, which is positioned at a distance from the centre line CL (seen in a plane transverse the axial direction X). A first piston rod 15′ is coupled to a first self-adjusting universal coupling 32′ of a first base member 23′. The first base member 23′ is furthermore coupled to a second 15″ and third 15′″ piston rod (see FIG. 4c) via a respective second 32″ and third 32′″ (see FIG. 4c) self-adjusting universal coupling. A guide bar 43 is slidingly arranged to the actuator block 16 and is fixed with one end to the first piston rod 15′. A fourth and fifth piston rod 15″″, 15 (see FIG. 4c) are coupled to the fundament 25 via a respective fourth 32′″ and fifth 32 (see FIG. 4c) self-adjusting universal coupling. FIG. 4b illustrates the fluid actuator arrangement 1 shown in FIG. 4a in an elevated state, wherein the first base member 23′ is pivoted. A first clamping element 13′ of the first piston body 5′ is released from the first piston rod 15′. A first clamping member 14′ of the second piston body 5″ is released from the first piston rod 15′ as well. The first piston rod 15′ is clamped by the static holding unit 17 by the first clamping unit 19′ holding the first piston rod 15′ temporary rigidly in fixed position. A second 13″ and third 13′″ (covered in figure) clamping element of the first piston body 5′ and a second 19″ and third 19′″ (covered in figure) clamping unit of the static holding unit 17 are released from the second 15″ and third 15′″ piston rods. The fourth 15″″ and fifth 15 (covered in figure) piston rods are released from respective a fourth and fifth clamping member 14″″, 14 of the second piston body 5″ and from a fourth 19″″ and a fifth 19 clamping unit of the static holding unit 17. The first piston body 5′ is clamped to the fourth 15″″ and fifth 15 piston rods and is moved in accordance with arrow aa and the second piston body 5″ is clamped to the second 15″ and third 15′″ piston rod and is moved in accordance with arrow bb. The first base member 23′ is thus turned and pivoted.

FIG. 4c schematically shows in a cross-sectional view the first piston body 5′ in FIG. 4b. The first piston body 5′ comprises a first through-bore 11′ and the first clamping element provided for releasable clamping onto the first piston rod 15′ and comprises a second through-bore 11″ and the second clamping element provided for releasable clamping onto the second piston rod 15″ and comprises a third through-bore 11′″ and the third clamping element provided for releasable clamping onto the third piston rod 15′″. The first piston body 5′ comprises a fourth through-bore 11′″ and the fourth clamping element provided for releasable clamping onto the fourth piston rod 15′″ and comprises a fifth through-bore 11 and the fifth clamping element provided for releasable clamping onto the fifth piston rod 15. The first clamping element comprises a flexible membrane serving as a flexible wall of a first space formed within the first piston body 5′ and co-axial with the first piston rod 15′. The first space is coupled to a fluid supply for fluid communication via a first fluid port positioned exterior the first cylinder housing 3′. The second clamping element comprises a flexible membrane serving as a flexible wall of a second space formed within the first piston body 5′ and co-axial with the second piston rod 15″. The second space is coupled to the fluid supply for fluid communication via a second fluid port positioned exterior the first cylinder housing 3′. The same design is due for a third, fourth, fifth space of the second piston body 5″.

First, second, third, fourth, fifth self-adjusting universal couplings 32′, 32″, 32′″, 32′″, 32 each being arranged in elongated guide members 36 that are oriented perpendicular to each other in a plane substantially extending transverse the axial direction X. The respective elongated guide member 36 is provided for guidance of the respective self-adjusting universal coupling along the respective elongated guide member 36. FIG. 4d schematically shows a cross-section of the first space and the flexible wall 61 adapted to be clamped around the first piston rod 15′.

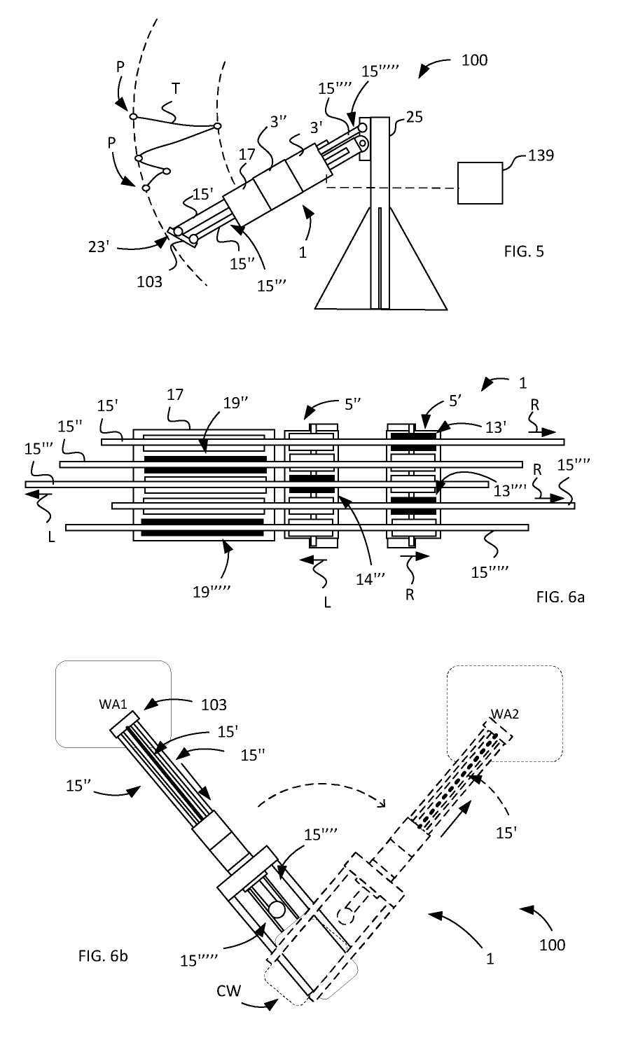

FIG. 5 illustrates a robot 100 according to one aspect of the invention. One end of a fluid actuator arrangement 1 is pivotally hinged to a fundament 25 for yaw and elevating motion, separately or in combination. The other end of the fluid actuator arrangement 1 comprises a first base member 23′ configuring a robot end effector 103. The fluid actuator arrangement 1 comprises a first, second, third, fourth, fifth clamping unit (not shown) of a static holding unit 17. The fluid actuator arrangement 1 further comprises a first, second, third, fourth, fifth clamping element (not shown) of a first piston body (not shown) of a first cylinder 3′ and comprises a first, second, third, fourth, fifth clamping member (not shown) of a second piston body (not shown) of a second cylinder 3″.

Preferably, an operator may perform an easy and fast trajectory T programming of the motion of the robot end effector 103 by manually moving the robot end effector 103 between desired operation positions P by disengaging the clamping units and disengaging the clamping elements and clamping members from the piston rods 15′, 15″, 15′″ (covered), 15′″, 15 (covered).

Suitably, the fluid actuator arrangement 1 comprises a sensor arrangement (not shown) coupled to a control unit 139, which is adapted to sense the actual position of the respective first, second, third, fourth, fifth piston rod during the trajectory T programming. During the trajectory T programming the fluid supply of the fluid actuator arrangement is unpressurized for easy motion of the robot end effector.

The robot end effector may be moved by hand manually or by means of another robot (not shown).

FIGS. 6a and 6b schematically illustrate a fluid actuator arrangement 1 according to a sixth example of the invention. FIG. 6a shows, as an example, that the step of moving a first piston body 5′ to a first and/or second position comprises the step of moving the first piston body a first full length stroke and the step of moving a second piston body 5″ to a first and/or second position comprises the step of moving the second piston body a first full length stroke. In FIG. 6a is shown that a first clamping element 13′ of the first piston body 5′ is activated to clamp around a first piston rod 15′ and that a fourth clamping element 13′″ of the first piston body 5′ is activated to clamp around a fourth piston rod 15″″. A respective second 19″ and fifth 19 clamping unit of a static holding unit 17 holds a second 15″ and fifth 15 piston rod in position. A third clamping member 14′″ of a second piston body 5″ is activated to clamp around a third piston rod 15′″. During the motion of the first 5′ piston body according to arrow R, the first 15′ and fourth 15″″ piston rod being moved according to arrow R and the third piston rod 15′″ is moved according to arrow L.

FIG. 6b illustrates a robot 100 adapted to a work station and a first work area WA1 and a second work area WA2 making use of the fluid actuator arrangement 1 in FIG. 6a. In the first work area position the first, second, third piston rods are retracted by clamping the first, second clamping elements/members alternatively thereby retraction the robot end effector 103. The fluid actuator arrangement 1 thereafter operates the robot 100 to make a turn in position for reaching the second work area WA2. This is achieved by activating the fourth 15″″ and fifth 15 piston rod. One piston rod is pushed from the cylinder housings and the other is pulled in the opposite direction, thereby providing a yaw action of the fluid actuator arrangement 1 (i.e. the robot end effector will be rotated to the second work area WA2. The fluid actuator arrangement 1 thereafter operates the robot 100 to extend the robot end effector 103 to the second work area WA2. The extension is made by moving the first piston rod 15′ toward the second work area WA2. After fulfilled extension, the robot end effector 103 is rotated (or makes a yaw motion). This is achieved by holding the first piston rod 15′ by the first clamping unit of the static holding unit and at the same time moving the second and third piston rod 15″, 15′″ by suitable operation of the second and third clamping element/member and moving the first and second piston body alternately or moving only one piston body a single stroke length. A counter weight CW is arranged to the robot.

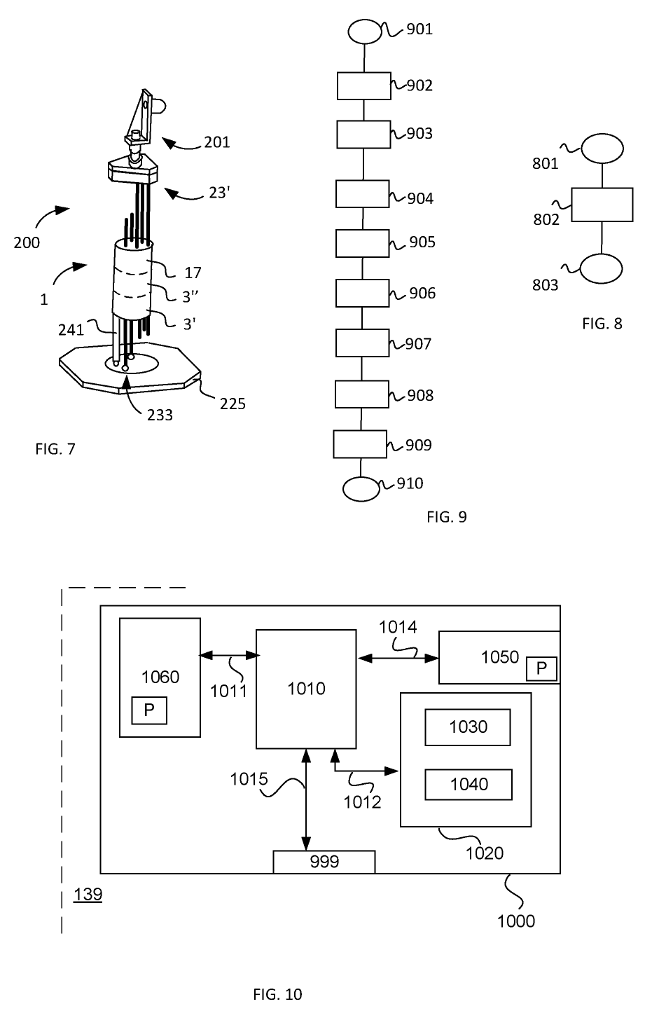

FIG. 7 illustrates a reconfigurable fixture unit 200 comprising a fluid actuator arrangement 1 according to one aspect of the invention. The reconfigurable fixture unit 200 is provided for different products or variants within one product family and for holding parts during assembly. A first base member 23′ of the fluid actuator arrangement comprises a top plate and a pickup 201. A known unit of today (e.g. a flexapod unit) consists of six legs coupled to the top plate, each leg having an individual hydraulic cylinder. According to one aspect of the invention, the fluid actuator arrangement 1 is adapted to and features the adjustment properties of a current unit. The reconfigurable fixture unit 200 can be integrated into a so called Boxioint system or positioned directly on a pedestal. The fluid actuator arrangement 1 comprises a first 3′ and a second 3″ cylinder housing and a static holding unit 17 comprising five clamping units (not shown). A first piston body (not shown) of the first cylinder housing comprises five clamping elements. A second piston body (not shown) of the second cylinder housing 3″ comprises five clamping members. Five piston rods, each extending through a respective clamping element/member/unit, are provided to the fluid actuator arrangement 1. The five piston rods share the respective first and second piston body. Two piston rods are coupled to a fundament 225 via a respective universal joint 233. A yaw arm 241 joins the fundament with the first and second cylinder housings 3′, 3″ for permitting a yaw motion of the reconfigurable fixture unit 200. Three piston rods are coupled to the top plate via a respective universal joint (not shown) for raising/lowering and pitch the pickup 201.

FIGS. 8 and 9 schematically illustrate exemplary flow charts of methods for providing a linear and rotational motion of a first base member of a fluid actuator arrangement according to further aspects of the invention.

FIG. 8 shows a method for providing a rotational motion of a first base member 23′ of a fluid actuator arrangement 1. The references are e.g. found in for example FIGS. 2a, 2b and FIG. 3. The fluid actuator arrangement 1 comprises a first cylinder housing 3′ comprising; a first piston body 5′ comprising a first through-bore 11′ and a first clamping element 13′ provided for releasable clamping onto a first piston rod 15′, wherein the first piston body 5′ comprises a second through-bore 11″ and a second clamping element 13″ provided for releasable clamping onto a second piston rod 15″; a first static holding unit 17 comprising; a first clamping unit 19′ provided for releasable clamping onto the first piston rod 15′; a second clamping unit 19″ provided for releasable clamping onto second piston rod 15″; a first base member 23, 23′ coupled to the first piston rod 15′ via a first universal joint 31, 32′, 34 for providing a rotational motion 81, T1 (also see FIG. 11b) of the first base member 23, 23′ during longitudinal motion of the first piston rod 15′ when clamped on the first piston rod 15′.

The method shown in FIG. 8 illustrates a first step 801 comprising the start of the method. A second step 802 illustrates a method for providing a rotational motion of the first base member of the fluid actuator arrangement 1. A third step 803 illustrates a stop of the method. The second step 802 may comprise the steps of; clamping the first piston rod 15′ by means of the first clamping element 13′; clamping the second clamping unit 19″ for holding the second piston rod 15″; and moving the first piston body 5′.

The method may alternately comprise a first step comprising the start of the method and a second step providing a linear and rotational motion of a first base member of a fluid actuator arrangement 1 comprising a first cylinder housing comprising a first piston body comprising a first through-bore and a first clamping element provided for releasable clamping onto a first piston rod, wherein the first piston body comprises a second through-bore and a second clamping element provided for releasable clamping onto a second piston rod; a first static holding unit comprising; a first clamping unit provided for releasable clamping onto the first piston rod; a second clamping unit provided for releasable clamping onto second piston rod; a first base member coupled to the first piston rod for providing longitudinal motion in an axial direction, wherein the second piston rod is coupled to the first base member or coupled to a second base member of the fluid actuator arrangement for providing a rotational motion of the first base member. A third step comprises a stop of the method. The second step may comprise the steps of; clamping the first piston rod by means of the first clamping element; moving the first piston body to a first position; clamping the first clamping unit for holding the first piston rod; clamping the second piston rod by means of the second clamping element; releasing the first clamping element from the first piston rod; and moving the first piston body to a second position.

FIG. 9 illustrates a further example of the method. Step 901 illustrates start of the method. Step 902 shows clamping the first clamping unit for holding the first piston rod. Step 903 shows clamping the second clamping unit for holding the second piston rod. Step 904 shows clamping the third clamping unit for holding the third piston rod. Step 905 shows releasing the first clamping element from the first piston rod. Step 906 shows releasing the second clamping element from the second piston rod. Step 907 shows releasing the third clamping element from the third piston rod. Step 908 shows clamping the fourth piston rod by means of the fourth clamping element and/or clamping the fifth piston rod by means of the fifth clamping element. Step 909 shows moving the first piston body to a third position. In Step 910 the method is fulfilled and stopped.

According to one aspect of the invention, the fluid actuator arrangement further comprising a second cylinder housing comprising a second piston body comprising a first through-hole and a first clamping member provided for releasable clamping onto the first piston rod; a second through-hole and a second clamping member provided for releasable clamping onto the second piston rod; a third through-hole and a third clamping member provided for releasable clamping onto a third piston rod; a fourth through-hole and a fourth clamping member provided for releasable clamping onto a fourth piston rod; a fifth through-hole and a fifth clamping member provided for releasable clamping onto a fifth piston rod. An exemplary embodiment comprises in optional order the method steps of clamping the first piston rod by means of the first clamping member; moving the second piston body to a first point; clamping the first clamping unit for holding the first piston rod and/or clamping the second clamping unit for holding the second piston rod; clamping the second a piston rod by means of the second clamping member and/or the third piston rod by means of the third clamping member; releasing the first clamping member; and moving the second piston body to a second point.

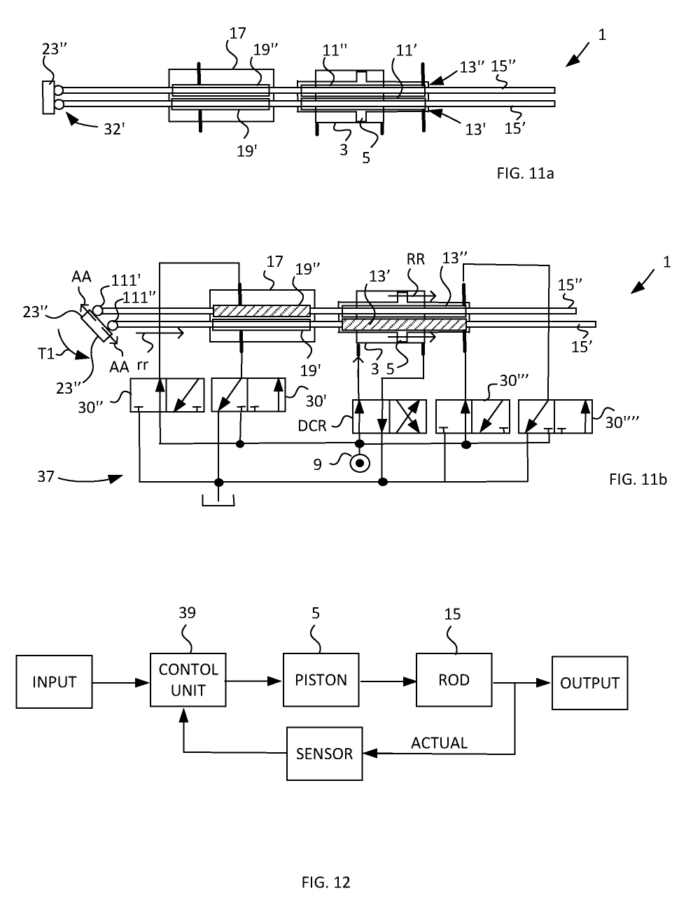

FIG. 10 illustrates a CPU device 1000 according to one aspect of the invention. The CPU device 1000 may be used in a control unit (e.g. reference 39 in FIG. 2a or reference 139 in FIG. 5) of a fluid actuator arrangement. The control unit 39, 139 is configured to control the linear and rotational motion of a first base member of the fluid actuator arrangement 1.

The control unit 39, 139 thus comprises the CPU device 1000 of a computer. The CPU device 1000 comprises a non-volatile memory NVM 1020, which is a computer memory that can retain stored information even when the computer is not powered. The CPU device 1000 further comprises a processing unit 1010 and a read/write memory 1050. The NVM 1020 comprises a first memory unit 1030. A computer program (which can be of any type suitable for any operational data) is stored in the first memory unit 1030 for controlling the functionality of the CPU device 1000. Furthermore, the CPU device 1000 comprises a bus controller (not shown), a serial communication left (not shown) providing a physical interface, through which information transfers separately in two directions. The CPU device 1000 may comprise any suitable type of I/O module (not shown) providing input/output signal transfer, an A/D converter (not shown) for converting continuously varying signals from detectors (not shown) of the fluid actuator arrangement and from other monitoring units (not shown) for detecting the positions of the piston rod and the common piston body, into binary code suitable for the computer. Other operational data may be actual loads, rotational velocity of the first base member etc.

The CPU device 1000 also comprises an input/output unit (not shown) for adaptation to time and date. The CPU device 1000 comprises an event counter (not shown) for counting the number of event multiples that occur from independent events in operation of the fluid actuator arrangement. Furthermore, the CPU device 1000 includes interrupt units (not shown) associated with the computer for providing a multi-tasking performance and real time computing for automatically adapting the speed of the first, second, third piston rods and other features in accordance with programmed data.

The NVM 1020 also includes a second memory unit 1040 for external controlled operation. A data medium storing program P may comprise routines for automatically adapting the speed of the common piston body in accordance with the actual fluid pressure and is provided for operating the CPU device 1000 for performing the method.

The data medium storing program P comprises a program code stored on a medium, which is readable on the computer, for causing the control unit 39, 139 to perform the method for controlling the rotational and linear motion of the first base member.

The data medium storing program P further may be stored in a separate memory 1060 and/or in the read/write memory 1050. The data medium storing program P, in this embodiment, is stored in executable or compressed data format.

It is to be understood that when the processing unit 1010 is described to execute a specific function that involves that the processing unit 1010 may execute a certain part of the program stored in the separate memory 1060 or a certain part of the program stored in the read/write memory 1050.

The processing unit 1010 is associated with a data port 999 for communication via a first data bus 1015. The non-volatile memory NVM 1020 is adapted for communication with the processing unit 1010 via a second data bus 1012. The separate memory 1060 is adapted for communication with the processing unit 1010 via a third data bus 1011. The read/write memory 1050 is adapted to communicate with the processing unit 1010 via a fourth data bus 1014. The data port 999 is preferably connectable to data links of a robot apparatus. When data is received by the data port 999, the data will be stored temporary in the second memory unit 1040. After that the received data is temporary stored, the processing unit 1010 will be ready to execute the program code, according to the above-mentioned method. Preferably, the signals (received by the data port 999) comprise information about operational status of the fluid actuator arrangement, such as operational status regarding the position of the respective first and second piston body relative each other and relative the cylinder housing. The signals may also comprise information about e.g. operational data regarding fluid pressure data and/or load data and/or fluid temperature, etc.

According to one aspect, signals received by the data port 999 may contain information about actual positions of piston rods and of the first base member by means of sensor members. The received signals at the data port 999 can be used by the CPU device 1000 for controlling and monitoring of the automatically adaptation of the speed and/or motion of the piston body in accordance with a predetermined value.

The signals received by the data port 999 can be used for automatically moving the piston body between two end positions. The signals can be used for different operations of the fluid actuator arrangement, such as operating the pressurization of each individual clamping element and/or clamping member and/or clamping unit. The information is preferably measured by means of suitable sensor members of the fluid actuator arrangement. The information can also be manually fed to the control unit via a suitable communication device, such as a computer display or a touchscreen.

The method can also partially be executed by the CPU device 1000 by means of the processing unit 1010, which processing unit 1010 runs the data medium storing program P being stored in the separate memory 1060 or the read/write memory 1050. When the CPU device 1000 runs the data medium storing program P, suitable method steps disclosed herein will be executed. A data medium storing program product comprising a program code stored on a medium is also provided, which product is readable on the computer, for providing a rotational motion of a first base member 23′ of a fluid actuator arrangement 1 comprising a first cylinder housing 3′ comprising; a first piston body 5′ comprising a first through-bore 11′ and a first clamping element 13′ provided for releasable clamping onto a first piston rod 15′, wherein the first piston body 5′ comprises a second through-bore 11″ and a second clamping element 13″ provided for releasable clamping onto a second piston rod 15″; a first static holding unit 17 comprising; a first clamping unit 19′ provided for releasable clamping onto the first piston rod 15′; a second clamping unit 19″ provided for releasable clamping onto second piston rod 15″; a first base member 23, 23′ coupled to the first piston rod 15′ via a first universal joint 31, 32′, 34 for providing a rotational motion R1, T1 of the first base member 23, 23′ during longitudinal motion of the first piston rod 15′ when clamped on the first piston rod 15′; wherein the method comprises the steps of; clamping the first piston rod 15′ by means of the first clamping element 13′; clamping the second clamping unit 19″ for holding the second piston rod 15″; and moving the first piston body 5′, when a data medium storing program P according to claim 22 is run on the control unit.

FIGS. 11a to 11b illustrate a fluid actuator arrangement according to one embodiment. The fluid actuator arrangement 1 comprises a cylinder 3 comprising a piston 5. The piston 5 includes a first through-bore 11′ and a first clamping element 13′ provided for releasable clamping onto a first rod 15′. The piston 5 comprises a second through-bore 11″, as is shown in FIG. 11a, and a second clamping element 13″ provided for releasable clamping onto a second rod 15″. The fluid actuator arrangement 1 further comprises a static holding unit 17. The static holding unit 17 comprises a first clamping unit 19′ provided for releasable clamping onto the first rod 15′. The static holding unit 17 comprises a second clamping unit 19″ provided for releasable clamping onto the second rod 15″. The fluid actuator arrangement 1 further comprises an end member 23″ coupled to the first rod 15′ via a first universal joint 32′ for providing a rotational motion R1 of the end member 23″ during a longitudinal motion of the first rod 15′ as is shown in FIG. 11b. FIG. 11b shows more in detail a valve arrangement 37 of the fluid actuator arrangement 1. A respective first and second 3/2-way valve 30′, 30″ is coupled to the respective first and second clamping unit 19′, 19″. The respective first and second 3/2-way valve 30′, 30″ is coupled to a fluid supply 9. The second 3/2-way valve 30″ is operated (by a control unit, not shown) to pressurize the second clamping unit 19″ for holding the second rod 15″.

A respective third and fourth 3/2-way valve 30′″, 30″″ is coupled to the respective first and second clamping element 13′, 13″. The respective third and fourth 3/2-way valve 30′″, 30″″ is coupled to a fluid supply 9. The third 3/2-way valve 30′″ is operated by the control unit to pressurize the first clamping element 13′ for engaging the piston 5 with the first rod 15′. A directional control valve DCR is coupled to the fluid supply 9 and is operated to pressurize the cylinder's 3 left chamber for moving the piston 5 according to arrow RR. The first rod 15′ will be moved according to the arrow rr. The second clamping unit 19″ holds the second rod 15″. This implies that the end member 23″ will be pitched according to arrow T1. Arrows AA indicate the movement of a first and second universal joint 111′, 111″ along the plane of the end member 23″. The first and second universal joint 111′, 111″ are journaled in guide members (not shown) of the end member 23″ so that the first and second rods 15′, 15″ not would bend during said pitching.

Alternatively, the fluid actuator arrangement 1 may comprise a main universal joint rigidly coupled between the end member 23″ and the static holding unit 17 and/or cylinder 3 (directly or indirectly) instead of the employment of a second rod 15″ coupled to the universal joint.

Preferably, the first piston rod and/or second piston rod are made hollow for saving weight.

The present invention is of course not in any way restricted to the preferred embodiments described above, but many possibilities to modifications, or combinations of the described embodiments, thereof should be apparent to a person with ordinary skill in the art without departing from the basic idea of the invention as defined in the appended claims.

One aspect may involve that the all clamping elements/members/units are adapted and arranged for momentary disengaging all piston rods in case the first base member propels a large mass using the kinetic energy of the mass (in a way reminding of a freewheel clutch). One aspect may involve that a first piston body force area is of the same area as that of a second piston body.

The clamping elements/members/units adapted and arranged for momentary disengaging all piston rods can be of any suitable number. For example, the fluid actuator arrangement may comprise a first static holding unit, a second static holding unit and/or a third static holding unit. The fluid actuator arrangement may comprise three or more cylinder housings each comprising a respective piston body comprising a first through-bore and a first clamping element provided for releasable clamping onto a first piston rod and each comprising a second through-bore and a second clamping element provided for releasable clamping onto a second piston rod.

1. A fluid actuator arrangement comprising:
a first cylinder housing comprising;
a first piston body slidingly arranged in the first cylinder housing, the first piston body comprising a first through-bore and a first clamping element provided for releasable clamping onto a first piston rod, characterized in that the first piston body comprises a second through-bore and a second clamping element provided for releasable clamping onto a second piston rod;
a first static holding unit comprising;
a first clamping unit provided for releasable clamping onto the first piston rod;
a second clamping unit provided for releasable clamping onto the second piston rod;
a first base member coupled to the first piston rod via a jointed coupling for providing a rotational motion of the first base member during longitudinal motion of the first piston rod;
the second piston rod is coupled to the first base member for providing the rotational motion of the first base member;
the first base member is coupled to a first end of the first piston rod and to a first end of the second piston rod.

2. The fluid actuator arrangement according to claim 1, wherein:
the first base member is coupled to the first piston rod for providing longitudinal motion of the first base member in an axial direction, wherein;
the second piston rod is coupled to a second base member of the fluid actuator arrangement for providing a rotational motion of the first base member.

3. The fluid actuator arrangement according to claim 1, the fluid actuator arrangement further comprising:
a third piston rod arranged through;
a third through-bore of the first piston body and a third clamping element provided for releasable clamping onto the third piston rod;
the first static holding unit comprising;
a third clamping unit provided for releasable clamping onto the third piston rod.

4. The fluid actuator arrangement according to claim 1, the fluid actuator arrangement further comprising:
at least four piston rods,
each of which is arranged through an individual through-bore of the first piston body and an individual clamping element provided for releasable clamping onto the respective piston rod, wherein
each of which is arranged through an individual clamping unit of the a first static holding unit provided for releasable clamping onto the respective piston rod.

5. The fluid actuator arrangement according to claim 1, the fluid actuator arrangement further comprising:
a second cylinder housing comprising;
a second piston body comprising a first through-hole and a first clamping member provided for releasable clamping onto the first piston rod, wherein;
the second piston body comprises a second through-hole and a second clamping member provided for releasable clamping onto the second piston rod.

6. The fluid actuator arrangement according to claim 2, the first piston body comprises:
a first through-bore and a first clamping element provided for releasable clamping onto a first piston rod;
a second through-bore and a second clamping element provided for releasable clamping onto a second piston rod;
a third through-bore and a third clamping element provided for releasable clamping onto a third piston rod;
a fourth through-bore and a fourth clamping element provided for releasable clamping onto a fourth piston rod;
a fifth through-bore and a fifth clamping element provided for releasable clamping onto a fifth piston rod, wherein;
the first piston rod is coupled to the first base member for providing a linear motion of the first base member;
the respective second and third piston rod is coupled to the first base member for providing a rotational motion of the first base member relative the first piston body;
the respective fourth and fifth piston rod is coupled to the second base member for providing a rotational motion of the first piston body.

7. The fluid actuator arrangement according to claim 2,
wherein the first base member is coupled to the first piston rod via a first universal joint and is coupled to the second piston rod via a second universal joint or the first base member is coupled to the first piston rod via a first universal joint and the second base member is coupled to the second piston rod via a third universal joint.

8. The fluid actuator arrangement according to claim 6, wherein
the first piston rod is coupled to the first base member via a first universal joint,
the second piston rod is coupled to the first base member via a second universal joint,
the third piston rod is coupled to the first base member via a third universal joint,
the fourth piston rod is coupled to the second base member via a fourth universal joint,
the fifth piston rod is coupled to the second base member via a fifth universal joint.

9. The fluid actuator arrangement according to claim 7, wherein
the second universal joint and the third universal joint are arranged in elongated guide members that are oriented perpendicular to each other in a plane substantially extending transverse the axial direction;
the fourth universal joint and the fifth universal joint are arranged in elongated guide members oriented perpendicular to each other,
the respective elongated guide member is provided for guidance of the respective universal joint along the respective elongated guide member.

10. The fluid actuator arrangement according to claim 2, wherein the second base member is coupled to the first cylinder housing and/or the first static holding unit and/or a second cylinder housing via a sixth universal joint.

11. The fluid actuator arrangement according to claim 1, wherein the first base member comprises a robot end effector.

12. The fluid actuator arrangement according to claim 1, wherein the first base member comprises a universal joint of an interlinked elongated manipulator.

13. The fluid actuator arrangement according to claim 1, wherein the first base member comprises a reconfigurable fixture unit provided for holding articles during assembly.

14. A method for providing a rotational motion of a first base member of a fluid actuator arrangement comprising a first cylinder housing comprising;
a first piston body slidingly arranged in the first cylinder housing, first piston body comprising a first through-bore and a first clamping element provided for releasable clamping onto a first piston rod, wherein
the first piston body comprises a second through-bore and a second clamping element provided for releasable clamping onto a second piston rod;
a first static holding unit comprising;
a first clamping unit provided for releasable clamping onto the first piston rod;
a second clamping unit provided for releasable clamping onto second piston rod;
a first base member coupled to the first piston rod via a jointed coupling joint for providing a rotational motion of the first base member during longitudinal motion of the first piston rod when clamped on the first piston rod;
the second piston rod is coupled to the first base member for providing the rotational motion of the first base member;
the first base member is coupled to a first end of the first piston rod and to a first end of the second piston rod;
the method comprises the steps of:
clamping the first piston rod by means of the first clamping element;
clamping the second clamping unit for holding the second piston rod; and
moving the first piston body.

15. The method according to claim 14 for providing a linear and rotational motion of a first base member of the fluid actuator arrangement; wherein
the first base member is coupled to the first piston rod for providing longitudinal motion in an axial direction, wherein the second piston rod is coupled to the first base member or coupled to a second base member of the fluid actuator arrangement for providing a rotational motion of the first base member, the method comprises the steps of:
clamping the first piston rod by means of the first clamping element;
moving the first piston body to a first position;
clamping the first clamping unit for holding the first piston rod;
clamping the second piston rod by means of the second clamping element;
releasing the first clamping element from the first piston rod; and
moving the first piston body to a second position.

16. The method according to claim 14, wherein
the first piston body further comprising:
a third through-bore and a third clamping element provided for releasable clamping onto a third piston rod;
a fourth through-bore and a fourth clamping element provided for releasable clamping onto a fourth piston rod;
a fifth through-bore and a fifth clamping element provided for releasable clamping onto a fifth piston rod,
the first static holding unit further comprising;
a third clamping unit provided for releasable clamping onto the third piston rod;
a fourth clamping unit provided for releasable clamping onto the fourth piston rod;
a fifth clamping unit provided for releasable clamping onto the fifth piston rod;
the first piston rod is coupled to the first base member for providing a linear motion of the first base member,
the respective second and third piston rod is coupled to the first base member for providing a rotational motion of the first base member relative the first piston body;
the respective fourth and fifth piston rod is coupled to the second base member for providing a rotational motion of the first piston body, the method comprises in optional order the steps of:
clamping the first piston rod by means of the first clamping element;
moving the first piston body to a first position;
clamping the first clamping unit for holding the first piston rod and/or clamping the second clamping unit for holding the second piston rod;
clamping the second a piston rod by means of the second clamping element and/or the third piston rod by means of the third clamping element;
releasing the first clamping element; and
moving the first piston body to a second position.

17. The method according to claim 16, wherein the method comprises in optional order or at the same time the further step of:
clamping the first clamping unit for holding the first piston rod;
clamping the second clamping unit for holding the second piston rod;
clamping the third clamping unit for holding the third piston rod;
releasing the first clamping element from the first piston rod;
releasing the second clamping element from the second piston rod;
releasing the third clamping element from the third piston rod;
clamping the fourth piston rod by means of the fourth clamping element and/or
clamping the fifth piston rod by means of the fifth clamping element; and
moving the first piston body to a third position.

18. The method according to claim 14, wherein the step of moving the first piston body to the first and/or second position comprises the step of moving the first piston body a first full length stroke.

19. The method according to claim 14, wherein the fluid actuator arrangement further comprising a second cylinder housing comprising a second piston body comprising:
a first through-hole and a first clamping member provided for releasable clamping onto the first piston rod;
a second through-hole and a second clamping member provided for releasable clamping onto the second piston rod;
a third through-hole and a third clamping member provided for releasable clamping onto a third piston rod;
a fourth through-hole and a fourth clamping member provided for releasable clamping onto a fourth piston rod;
a fifth through-hole and a fifth clamping member provided for releasable clamping onto a fifth piston rod,
the method comprises in optional order the steps of:
clamping the first piston rod by means of the first clamping member;
moving the second piston body to a first point;
clamping the first clamping unit for holding the first piston rod and/or clamping the second clamping unit for holding the second piston rod;
clamping the second piston rod by means of the second clamping member and/or the third piston rod by means of the third clamping member;
releasing the first clamping member 444; and
moving the second piston body to a second point.

20. The method according to claim 14, wherein the method comprises the step of providing a trajectory programming the motion of the first base member by moving the first base member between desired operation positions.

21. A robot apparatus comprising a control unit configured to control the motion of a first base member, the control unit is coupled to a fluid actuator arrangement according to claim 1.

22. A reconfigurable fixture unit provided for holding articles during assembly, which reconfigurable fixture unit comprises a control unit configured to control the motion of a first base member, the control unit is coupled to a fluid actuator arrangement according to claim 1.

23. A data medium storing program adapted for providing a motion of a first base member of a robot apparatus according to claim 21, wherein said data medium storing program comprises a program code stored on a medium, which is readable on a computer, for causing the control unit to perform the method steps of:
clamping the first piston rod by means of the first clamping element;
clamping the second clamping unit for holding the second piston rod; and;
moving the first piston body.

24. A data medium storing program product comprising a program code stored on a medium, which is readable on a computer, for performing the method steps according to claim 14.
